(19) United States
(12) Patent Application Publication
(10) Pub. No.: US 2026/0035598 A1
(43) Pub. Date: Feb. 5, 2026

(54) METHOD OF APPLYING GRAPHICS TO A SURFACE AND APPLIQUÉS FOR APPLICATION TO A SURFACE

(71) Applicant: INK-DIRECT LLC, Bergenfield, NJ (US)

(72) Inventors: Warren GODRIDGE, Bergenfield, NJ (US); Josilyn MARTINEZ, Bergenfield, NJ (US)

(73) Assignee: INK-DIRECT LLC, Bergenfield, NJ (US)

(21) Appl. No.: 18/791,896

(22) Filed: Aug. 1, 2024

(51) Int. Cl. C09J 7/30; C09J 5/00; C09J 7/40

(52) U.S. Cl. CPC C09J 7/30; C09J 5/00; C09J 7/401; C09J 2421/00; C09J 2423/105

(57) ABSTRACT

An appliqué including: a base layer; a graphic layer disposed on a first surface of the base layer, the graphic layer having a graphic printed in reverse on the base layer; an adhesive layer disposed directly on the graphic layer; and a removable liner disposed on the adhesive layer. Alternatively, the appliqué can include a first removable liner; an adhesive layer disposed on the first removable liner; a graphic layer directly disposed on the adhesive layer, the graphic layer having a graphic printed right reading on the adhesive layer; and an optional second removable liner disposed on the graphic layer.

### BACKGROUND

### Field

The present disclosure relates to appliqués and methods for applying the same and more particularly to appliqués and methods for applying graphics to surfaces.

In the present disclosure, the term “appliqué” is used in a general sense as a graphic that is applied, or transferred, to a surface of something else, such as to a floor, wall, counter, ceiling and the like. Such “appliqué” may alternatively be referred to as a “decal,” particularly for smaller sized “appliqués.” As used herein, “appliqué” includes a decal, regardless of the size thereof. Furthermore, as used herein, the term “graphic” includes a design, an illustration, text, a print, a decoration, photographs, drawings, line art, mathematical graphs, line graphs, charts, diagrams, typography, numbers, symbols, geometric designs, maps, engineering drawings, patterns, solid blocks of color, or any other images. As also used herein, the term “graphic layer” means anything that visually alters the underlying surface on which the applique is applied (e.g. ink, paint, pigmented liquid, clear varnish etc.).

### Prior Art

There is a need in the art for application of graphics and images to surfaces, such as flat surfaces, walls, floors, counters, ceilings and the like. However, conventional methods and products for such application are limited and each suffer disadvantages, such as being expensive, limited in detail, limited in application surface, are too thick, are not environmentally friendly, are time consuming to produce and apply, and may not be durable.

Printed vinyl graphics are known for application to surfaces. However, printed vinyl graphics have a substantial thickness and/or texture to them (which is particularly noticeable in floor-applied printed vinyl graphics), and printed vinyl graphics are not environmentally friendly.

Also known are stencil painted graphics where a series of stencils are used, each having a different color, for applying a graphic to a surface. Such methods, particularly in producing the series of stencils is expensive and can be very challenging to locate each stencil in the proper position to obtain the desired graphic. Also, the series of stencils used to apply the graphic is very limited in terms of intricacy and detail.

Graphics are also known that are applied by a skilled artist freehand painting the graphics to a surface. Since a skilled artist is required and the process is completely manual, this method can be very expensive and time consuming.

Wallcoverings are also known for applying graphics to a surface. However, wallcoverings are only generally used for applying graphics to a large surface area and can be very expensive to both produce and for a skilled worker to apply. Obviously, the use of wallcovering is limited to walls and ceilings, and are not used to apply graphics to floors.

Rub-down transfers (e.g. temporary tattoos) can also be used to apply graphics to surfaces. However, the same are generally limited in size and durability.

Typically in the art of printing, the intention is to get the layer(s) of ink that you are printing to adhere firmly to whatever surface you are printing on (such as, vinyl, wallcovering, paper, etc.). Ink adhesion is a key factor in all printing, and insufficient adhesion often leads to rejection of any printed matter that displays poor adhesion characteristics.

### SUMMARY

Accordingly, an appliqué is provided. The appliqué comprising: a base layer; a graphic layer disposed on a first surface of the base layer, the graphic layer having a graphic printed in reverse on the base layer; an adhesive layer disposed directly on the graphic layer; and a removable liner disposed on the adhesive layer.

The base layer can be a non-ink receptive media. The base layer can comprise a flexible film, such as craft paper, PVC film, vinly film or a polyproylene layer. The flexible film can have a thickness ranging from 0.003 inches to 0.010 inches, such as 0.0045 inches.

The graphic layer can dry as a solid prior to the adhesive layer being disposed on the graphic layer. The graphic layer can have a thickness ranging from 001 inches to 0.004 inches, such as 0.001 inches.

The graphic layer can be one or more of an ink layer, a paint layer, a liquid pigment layer, and the clear varnish. The graphic layer can also be the adhesive layer, or a portion thereof.

The adhesive layer can be a rubber adhesive. The adhesive layer can have a thickness ranging from 0.001 inches to 0.003 inches, such as 0.002 inches.

The removable liner can be polyproylene. The removable liner can have a thickness ranging from 0.003 inches to 0.007 inches, such as 0.0055 inches.

Further provided is an appliqué comprising: a first removable liner; an adhesive layer disposed on the first removable liner; a graphic layer directly disposed on the adhesive layer, the graphic layer having a graphic printed right reading on the adhesive; and a second removable liner disposed on the graphic layer.

The first removable liner can be polyproylene. The first removable liner layer can have a thickness ranging from 0.003 inches to 0.007 inches, such as 0.0055 inches.

The adhesive layer can be a rubber adhesive. The adhesive layer can have a thickness ranging from 0.001 inches to 0.003 inches, such as 0.002 inches.

The graphic layer can dry as a solid prior to the second removable liner being disposed on the graphic layer. The graphic layer can have a thickness ranging from 0.001 inches to 0.004 inches, such as 0.001 inches.

The graphic layer can be one or more of an ink layer, a paint layer, a liquid pigment layer, and the clear varnish. The graphic layer can also be the adhesive layer, or a portion thereof.

The second removable liner can be paper with a low-tack adhesive. The second removable liner layer can have a thickness ranging from 0.004 inches to 0.007 inches, such as 0.006 inches.

Still further provided is a method for manufacturing an appliqué. The method comprising: printing a graphic layer on a first surface of a base layer, the graphic layer having a graphic printed in reverse on the base layer; and directly disposing an adhesive layer on the graphic layer. The method can further comprise disposing a removable liner on the adhesive layer.

The method can further comprise: removing the removable liner from the adhesive layer; adhering the adhesive layer to a surface; and removing the base layer from the graphic layer to leave the graphic layer adhered to the surface by the adhesive layer.

Still further yet provided is a method for manufacturing an appliqué to a surface. The method comprising: disposing an adhesive layer on the a first removable liner; directly printing a graphic layer on the adhesive layer, the graphic layer having a graphic printed right reading on the adhesive; and disposing a second removable liner on the graphic layer.

The method can further comprise: removing the first removable liner from the adhesive layer; adhering the adhesive layer to a surface; and removing the second removable liner from the graphic layer to leave the graphic layer adhered to the surface by the adhesive layer.

### BRIEF DESCRIPTION OF THE DRAWINGS

Further characteristics will become apparent from the description of the embodiments together with the claims and the included drawings. Embodiments can fulfill individual characteristics or a combination of several characteristics.

The embodiments are described below, without restricting the general intent of the invention, based on exemplary embodiments, wherein reference is made expressly to the drawings with regard to the disclosure of all details that are not explained in greater detail in the text. In the drawings:

FIG. 1A illustrates an appliqué according to a first embodiment, pre-trimming.

FIG. 1B illustrates the applique according to the first embodiment of FIG. 1A, post-trimming.

FIG. 1C illustrates the appliqué according to the first embodiment of FIG. 1B, applied to a surface.

FIG. 2A illustrates an appliqué according to a second embodiment, pre-trimming.

FIG. 2B illustrates the appliqué according to the second embodiment of FIG. 2A, post-trimming.

FIG. 2C illustrates the appliqué according to the second embodiment of FIG. 2B, applied to a surface.

FIG. 3A illustrates a flatbed printer for manufacturing the appliqué according to a first embodiment, pre-trimming.

FIG. 3B illustrates a laminator for manufacturing the appliqué according to a first embodiment of FIG. 1A, pre-trimming.

FIG. 3C illustrates a flat-bed cutting machine for trimming the appliqué according to a first embodiment of FIG. 1B.

FIG. 4A illustrates a first example of an appliqué according to the first embodiment.

FIG. 4B illustrates a second example of an appliqué according to the second embodiment.

FIG. 4C illustrates a third example of an applique according to the second embodiment.

### DETAILED DESCRIPTION

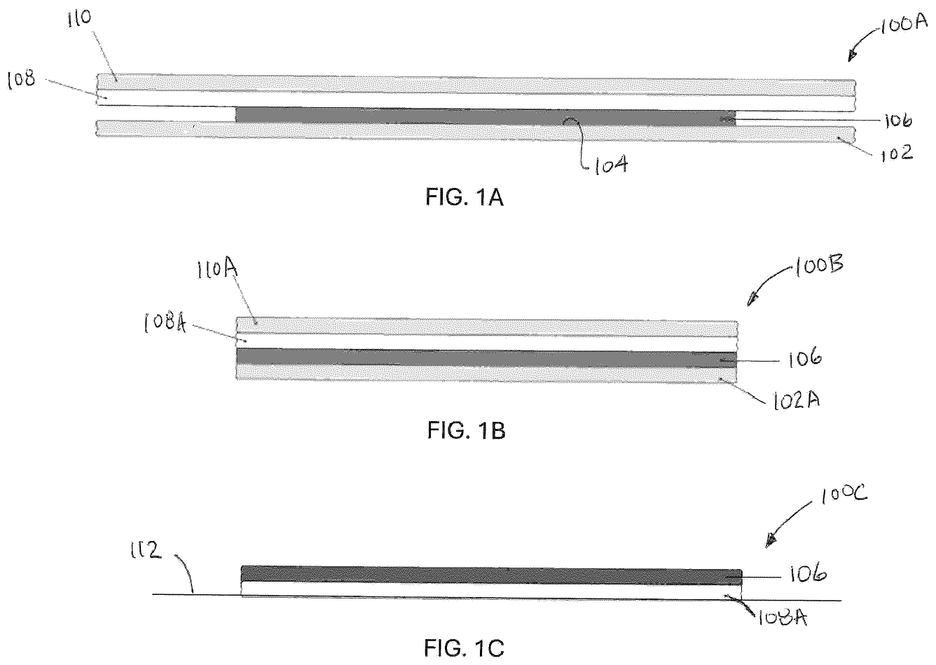

Turning first to FIGS. 1A-1C, the same illustrates a first embodiment of an appliqué to be applied to a surface, such as a flat surface. The appliqué can also be applied to a curved surface, for example, a gently curved surface, such as a surface curved in only one direction. The applique can be any size, including up to 120″×60″, which is only limited by the equipment used to manufacture the appliqué.

The appliqué, generally referred to by reference numeral 100A in FIG. 1A, in a pre-trimmed configuration, comprises a base layer 102. Most mediums (papers, vinyls, wallcoverings) are produced so as to be print receptive, however, the appliqué 100A utilizes a base layer 102 medium (aka carrier) that does not provide good print adhesion (e.g., a non-ink receptive media), such as a flexible film, such as craft paper, PVC film, vinyl film or a polyproylene layer. The flexible film can be a commercially available rolled product such as a water resistant polyproylene film having a thickness ranging from 0.003 inches to 0.010 inches, such as 0.0045 inches. The base layer 102 is cut to a overall size sufficient to fit the overall size of the graphic.

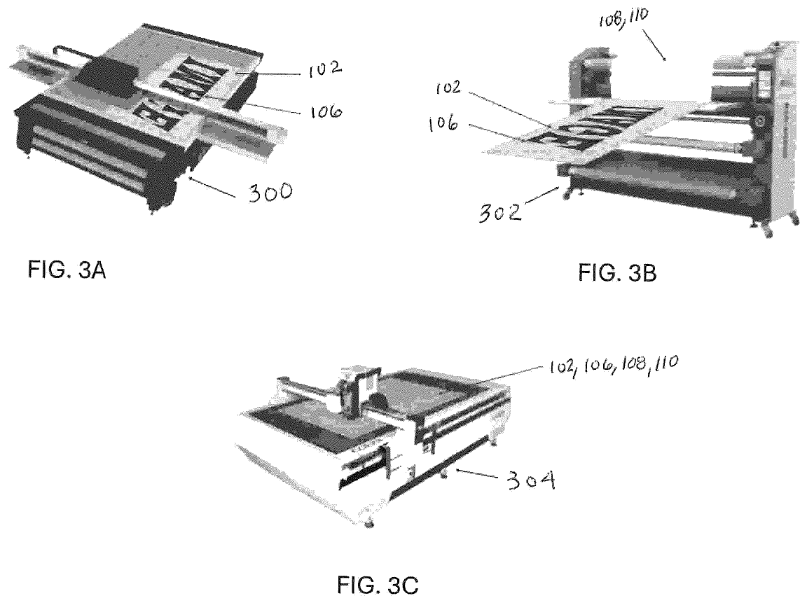

A graphic layer 106 disposed on a first surface 104 of the base layer 102. The graphic layer 106 having a graphic printed in reverse on the base layer 102. The graphic layer 106 is disposed on the base layer using a commercially available flatbed or roll to roll printer, such as a Canon Arizona 2360 flatbed or Canon Colorado M Series (see e.g., FIG. 3A). The graphic to be reproduced in the graphic payer 106 is printed in reverse (wrong reading) onto the base layer 102 and can be cured as part of the printing process so that the graphic layer transforms from a liquid state to a solid state. The graphic layer 106 can have a thickness ranging from 0.001 inches to 0.004 inches, such as 0.001 inches. The graphic layer 106 can be one or more of an ink layer, a paint layer, a liquid pigment layer, and the clear varnish. The graphic layer can also be the adhesive layer, or a portion thereof which visually alters the underlying surface on which the appliqué 100A is applied.

The appliqué 100A further comprises an adhesive layer 108 disposed directly on the graphic layer 106. As discussed above, the graphic layer 106 can dry as a solid prior to the adhesive layer 108 being disposed on the graphic layer 106. The adhesive layer 108 can be based on any known material, such as rubber based, acrylic based, epoxy based, polyurethane based, urethane based and the like and can have any form, such as sheet form, roll form, sprayed on, brushed on and the like. The adhesive layer 108 can have a thickness ranging from 0.001 inches to 0.003 inches, such as 0.002 inches. That is, once the graphic layer 106 (i.e., having the graphic) has been printed wrong reading to the base layer 102, the adhesive layer 108, which can be a commercially available adhesive coating, such as “Quality Media Mega Bond adhesive,” is applied to an exposed surface of the graphic layer 106 in order to allow the graphic layer 106 (i.e., the graphic) to be subsequently adhered to a surface 112 (see FIG. 1C). The adhesive layer 108 can be applied using a commercially available cold roll laminator, such as the “Royal Sovereign Laminator RCH-6500H.”

A removable liner 110 is disposed to cover the adhesive layer 108. The removable liner 110 can be provided as part of the adhesive layer 108 such that the adhesive layer 108 is not exposed until the time of application of the finished graphic appliqué 100B (see FIG. 1B). The removable liner 110 can be polyproylene and have a thickness ranging from 0.003 inches to 0.007 inches, such as 0.0055 inches. The adhesive layer 108 and removable liner 110 can be provided together and applied to the graphic layer in a single step by the laminator (see e.g., FIG. 3B), such as in a roll.

Turning next to FIG. 1B, the appliqué 100A is shown after trimming to remove excess base layer 102, adhesive layer 108 and/or removable liner 110 to produce appliqué 100B having a trimmed base layer 102A, a trimmed adhesive layer 108A and a trimmed removable liner 110A, as shown in FIG. 1B. The graphic layer 106 is not typically trimmed since it is typically printed to the required size and shape. Such trimming can be either hand trimmed or machine trimmed using equipment such as a Colex Flatbed Cutting Machine. Of course, the removable liner 110, adhesive layer 108 and the base layer 102 can each be provided in a size that does not require trimming (i.e., in the configuration of FIG. 1B), thereby eliminating the trimming process. Furthermore, the graphic layer 106 may also be trimmed, such as where multiple graphics are printed in the same graphic layer 106 and such appliqué 100A is trimmed to separate the individual graphics into multiple appliqués 100B.

To apply applique 100B to a surface 112, the removable liner 110A is removed from the adhesive layer 108A. Next, the adhesive layer 108A is adhered to the surface 112. After the adhesive layer 108A is adhered to the surface 112, the base layer 102A is removed from the graphic layer 106 to leave the graphic layer 106 adhered to the surface 112 by the adhesive layer 108A, leaving only the graphic layer 106 adhered to the surface 112 in right reading format.

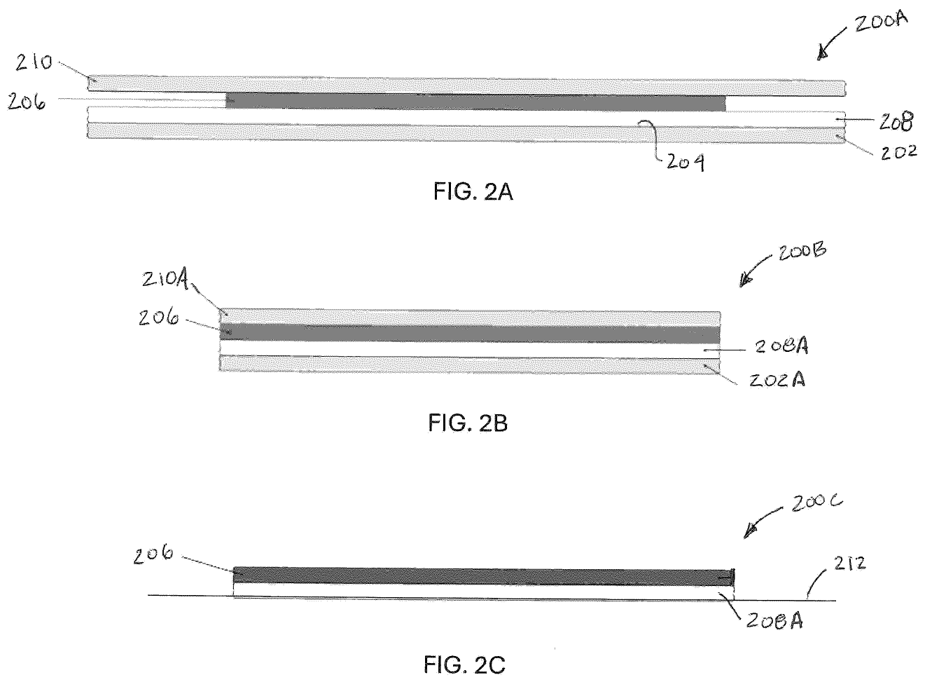

Referring now to FIGS. 2A-2C, there is shown a second embodiment of an appliqué for application to a surface. Similarly to the first embodiment, the appliqué of the second embodiment can also be applied to a flat surface or a curved surface, for example, a gently curved surface, such as a surface curved in only one direction. As with the applique of the first embodiment, the size of the applique of the second embodiment is only limited by the equipment used to manufacture the appliqué.

The appliqué, generally referred to by reference numeral 200A in FIG. 2A, in a pre-trimmed configuration, comprises a first removable liner 202. An adhesive layer 208 is disposed on a surface 204 of the first removable liner 202. The first removable liner 202 can be polyproylene and can have a thickness ranging from 0.003 inches to 0.007 inches, such as 0.0055 inches. The adhesive layer 208 can be a rubber adhesive and can have a thickness ranging from 0.001 inches to 0.003 inches, such as 0.002 inches.

The adhesive layer 208 can be provided together on a roll with the first removable liner 204 on the surface 204 and with an additional removable liner (not shown) on another surface of the adhesive layer 208. In this instance the material is trimmed to an appropriate sheet size and placed on and secured to the bed of a printer, at which time the other liner is removed exposing the adhesive layer 208. Thus, the first removable liner 202, together with the adhesive layer 208 (and the other liner) can be cut to a overall size sufficient to fit the overall size of the graphic.

A graphic layer 206 is directly disposed on the adhesive layer 208 with the graphic layer 206 having a graphic printed right reading on the adhesive layer 208. Similarly as discussed above with regard to the first embodiment, the graphic layer 206 can dry as a solid prior to a second removable liner 210 being disposed on the graphic layer 206. The graphic layer 206 can have a thickness ranging from 0.001 inches to 0.004 inches, such as 0.001 inches. The graphic layer 106 can be one or more of an ink layer, a paint layer, a liquid pigment layer, and the clear varnish. The graphic layer can also be the adhesive layer, or a portion thereof which visually alters the underlying surface on which the appliqué 100A is applied.

The second removable liner 210 is optionally disposed on the graphic layer 206. The second removable liner 210 can be paper with a low-tack adhesive and can have a thickness ranging from 0.004 inches to 0.007 inches, such as 0.006 inches. The second removable liner can be any commerically available liner, such as 3M™ SCPM-44X Premasking Tape.

Turning next to FIG. 2B, as with the applique of the first embodiment, the applique 200A is shown after trimming to remove excess of the first removable liner 202, adhesive layer 208 and the optional second removable liner 210 to produce appliqué 200B having a trimmed first removable liner 202A, a trimmed adhesive layer 208A and a trimmed second removable liner 210A, as shown in FIG. 2B. As discussed above with regard to the first embodiment, the graphic layer 206 is not typically trimmed since it is typically printed to the required size and shape. Such trimming can be either hand trimmed or machine trimmed using equipment such as a Colex Flatbed Cutting Machine. Of course, the removable liner 210, adhesive layer 208 and the base layer 202 can each be provided in a size that does not require trimming (i.e., in the configuration of FIG. 2B), thereby eliminating the trimming process. Furthermore, the graphic layer 206 may also be trimmed, such as where multiple graphics are printed in the same graphic layer 206 and such appliqué 200A is trimmed to separate the individual graphics into multiple appliqués 200B.

To apply appliqué 200B to a surface 212, the first removable liner 202A is removed from the adhesive layer 208A. Next, the adhesive layer 208A is adhered to the surface 212. After the adhesive layer 208A is adhered to the surface 212, the second removable liner 210A is removed from the graphic layer 206 to leave the graphic layer 206 adhered to the surface 212 by the adhesive layer 208A, leaving appliqué 200, as shown in FIG. 2C, having only the graphic layer 206 adhered to the surface 212 in right reading format.

The same equipment mentioned with regard to the first embodiment can also be used in the manufacture of the second embodiment. In addition, the second removable liner can be applied using a commercially available cold roll laminator, such as the Royal Sovereign Laminator RCH-6500H.

While the different layers of the appliques of the first and second embodiments are disclosed above with regard to exemplary materials and thicknesses, those skilled in the art will appreciate that materials and thicknesses other than the exemplary materials and thicknesses disclosed above can be utilized in producing such appliqués.

Those skilled in the art will appreciate that the appliques of the first and second embodiments represent a great advantage over prior art printing techniques and products with regard to ink adhesion, permitting the graphic layer to be applied to a surface and remain intact as if it was printed directly on such surface. That is, the appliqués of the first and second embodiments provide an appearance of a graphic that has been printed directly on a surface as opposed to having an intermediate substrate between the graphic and the surface. In addition, levels of detail that are unachievable with stencil painting or freehand painting can be achieved in a faster and more cost effective way and have a lower profile than vinyl prints.

Turning next to FIGS. 3A-3C, there are shown exemplary equipment for producing the appliqués of the first and second embodiments. FIG. 3A illustrates a flat-bed printer 300 having graphic layer 106 printed in reverse on a surface 104 of a base layer 102, such as a non-ink receptive media. FIG. 3B illustrates a laminator 302 having the graphic layer 106 printed in reverse on a surface 104 of a base layer 102 and having the adhesive layer 108 and removable liner 110 being applied thereto in a single step. FIG. 3C illustrates a flatbed cutting machine 304 trimming the base layer 102, adhesive layer 108 removable liner 110. Although FIGS. 3A-3C are described with regard to the appliqué of the first embodiment, such equipment can also be used to produce the appliqué of the second embodiment.

### EXAMPLES

### Example 1: Wet Application Method

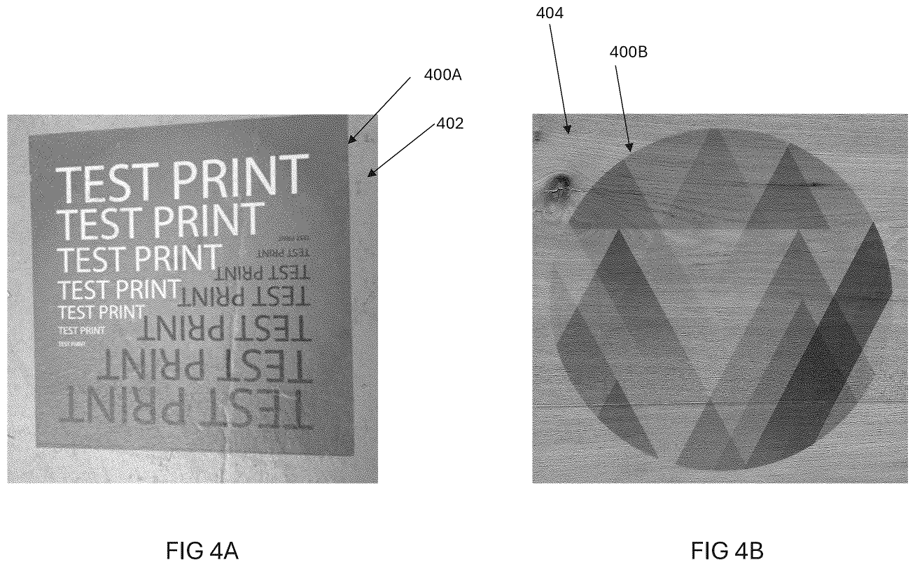

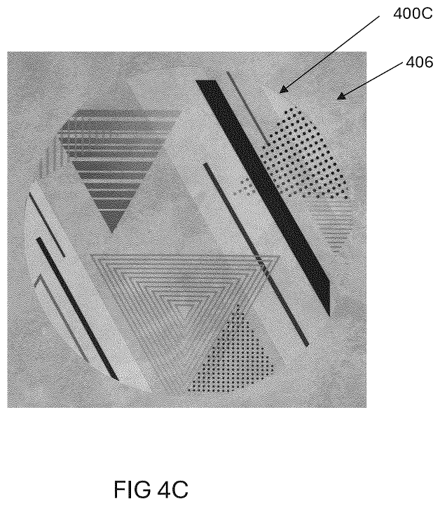

The graphic 400A in FIG. 4A was applied to the surface 402 with the production method and appliqué 100B of the first embodiment to a polished concrete floor (as the “application surface”). The application surface 402 was brushed clean and wiped down with a damp cloth. The application surface 402 was then sprayed with a mix of water and a mild detergent, such as baby shampoo, in order to wet the receiving area of the surface 402. The removable liner 110A was removed from the adhesive layer 108A and the adhesive layer 108A was then sprayed using the same water/mild detergent solution.

With the removable liner 110A removed, the adhesive layer 108A of the appliqué 100B was then positioned on the application surface 402, and using a graphic squeegee with base layer 102 applied, the water was pushed out from behind the graphic working from the center to the edge. Once all the water had been removed, the graphic was left overnight for the adhesive to cure fully and for a strong bond to occur between the graphic and the receiving surface 402. The base layer 102 was then removed.

### Example 2: Dry Application Method

The graphic 400B in FIG. 4B was applied to a wooden floor as the application surface 404 with the production method and applique 200B of the second embodiment. The application surface 404, was brushed clean and wiped down with a damp cloth.

The first removable liner 202A was peeled back by about 1″ from the adhesive layer 208A to expose an edge portion of the graphic and the edge portion of the graphic was located onto the application surface 404 with the exposed portion of the adhesive layer being pressed firmly onto the surface.

The rest of the first removable liner 202B was then gently peeled away while at the same time a graphic squeegee was used directly on the graphic layer 206 to press the adhesive layer down firmly onto the application surface 404. The second removable liner 210A was then removed.

### Example 3: Dry Application Method

The graphic 400C in FIG. 4C was applied to a ceramic wall tile as the application surface 406 with the production method and appliqué 200B of the second embodiment. The application surface 406 was brushed clean and wiped down with a damp cloth.

The first removable liner 202B was peeled back by about 1″ from the adhesive layer 208B to expose an edge portion of the graphic and the edge portion of the graphic was located onto the receiving surface 406 with the exposed portion of the adhesive layer being pressed firmly onto the surface.

The rest of the first removable liner 202B was then gently peeled away while at the same time a graphic squeegee was used directly on the graphic layer 206 to press the adhesive layer down firmly onto the receiving surface. The second removable liner 210A was then removed.

Although the Examples are shown having circular shape graphics, the production methods and appliqués of the first and second embodiments can be applied in any size or shape graphic and can be applied to other surfaces, such as ceilings, countertops etc.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An appliqué comprising:
a base layer;
a graphic layer disposed on a first surface of the base layer, the graphic layer having a graphic printed in reverse on the base layer;
an adhesive layer disposed directly on the graphic layer; and
a removable liner disposed on the adhesive layer.

2. The applique according to claim 1, wherein the base layer is a non-ink receptive media.

3. The appliqué according to claim 1, wherein the base layer comprises a flexible film.

4. The appliqué according to claim 3, wherein the flexible film having a thickness ranging from 0.003 inches to 0.010 inches.

5. The appliqué according to claim 1, wherein the graphic layer dries as a solid prior to the adhesive layer being disposed on the graphic layer.

6. The appliqué according to claim 5, wherein the graphic layer having a thickness ranging from 0.001 inches to 0.004 inches.

7. The appliqué according to claim 1, wherein the graphic layer comprising one or more of an ink layer, a paint layer, a liquid pigment layer, and a clear varnish layer.

8. The appliqué according to claim 1, wherein the adhesive layer is a rubber adhesive.

9. The appliqué according to claim 8, wherein the adhesive layer having a thickness ranging from 0.001 inches to 0.003 inches.

10. The appliqué according to claim 1, wherein the removable liner is polyproylene.

11. The applique according to claim 10, wherein the removable liner having a thickness ranging from 0.003 inches to 0.007 inches.

12. An appliqué comprising:
a first removable liner;
an adhesive layer disposed on the first removable liner; and
a graphic layer directly disposed on the adhesive layer, the graphic layer having a graphic printed right reading on the adhesive layer.

13. The applique according to claim 12, wherein the first removable liner is polyproylene.

14. The applique according to claim 13, wherein the first removable liner layer having a thickness ranging from 0.003 inches to 0.007 inches.

15. The applique according to claim 12, wherein the adhesive layer is a rubber adhesive.

16. The appliqué according to claim 15, wherein the adhesive layer having a thickness ranging from 0.001 inches to 0.003 inches.

17. The appliqué according to claim 12, wherein the graphic layer dries as a solid prior to the second removable liner being disposed on the graphic layer.

18. The applique according to claim 17, wherein the graphic layer having a thickness ranging from 0.001 inches to 0.004 inches.

19. The applique according to claim 12, further comprising a second removable liner disposed on the graphic layer.

20. The applique according to claim 12, wherein the graphic layer comprising one or more of an ink layer, a paint layer, a liquid pigment layer, and a clear varnish layer.

21. The applique according to claim 12, wherein the second removable liner is paper with a low-tack adhesive.

22. The appliqué according to claim 21, wherein the second removable liner layer having a thickness ranging from 0.004 inches to 0.007 inches.

23. A method for manufacturing an applique, the method comprising:
printing a graphic layer on a first surface of a base layer, the graphic layer having a graphic printed in reverse on the base layer;
directly disposing an adhesive layer on the graphic layer; and
disposing a removable liner on the adhesive layer.

24. The method according to claim 23, further comprising:
removing the removable liner from the adhesive layer;
adhering the adhesive layer to a surface; and
removing the base layer from the graphic layer to leave the graphic layer adhered to the surface by the adhesive layer.

25. A method for manufacturing an appliqué to a surface, the method comprising:
disposing an adhesive layer on a first removable liner;
directly printing an graphic layer on the adhesive layer, the graphic layer having a graphic printed right reading on the adhesive.

26. The method according to claim 25, further comprising disposing a second removable liner on the graphic layer.

27. The method according to claim 26, further comprising:
removing the first removable liner from the adhesive layer;
adhering the adhesive layer to a surface; and
removing the second removable liner from the graphic layer to leave the graphic layer adhered to the surface by the adhesive layer.
